(19) United States
(12) Patent Application Publication
(10) Pub. No.: US 2005/0072876 A1
(43) Pub. Date: Apr. 7, 2005

(54) Variably angled propulsion/steering system

(76) Inventor: Ricardo A Ducasse, New York, NY (US)

Correspondence Address: Ricardo A Ducasse, 175 E 3rd Street, Apt #2A, New York, NY, 10009, US

(21) Appl. No.: 10/500,258

(22) PCT Filed: Dec. 26, 2002
(86) PCT No.: PCT/US02/41263

(30) Foreign Application Priority Data
Dec. 26, 2001 (US) 60344593

(51) Int. Cl. B64B 1/20

(52) U.S. Cl. 244/23 D

(57) ABSTRACT

An aircraft equipped with peripherally configured directional thrust capability has an onboard primary power source producing compressed air, and at least two thrust producing modules. Each thrust producing module has a fuel source and receives compressed air from the primary power source. Each module is attached to a respective rotatable support structure for independently varying the thrust angle of the thrust producing module with respect to the aircraft, all thrust producing modules being connected to a common controller for coordinated control of the aircraft.

### CROSS REFERENCE TO RELATED APPLICATIONS

This application relates to and claims priority of pending U.S. Provisional Patent Application Ser. No. 60/344,593, filed Dec. 26, 2001.

### BACKGROUND

1. Field of Invention

This invention relates to the field of aeronautics and jet/rocket propulsion systems and, in particular, to integrated, multiply vectorable jet/rocket propulsion systems incorporating all essential aspects of airborne operations including, but not limited to, the functions of propulsion/steering/stabilization as well as, braking, hovering, and VTOL and STOL operations.

2. Background

It is very difficult to make anything more than general, segmented comparisons between the Variably Angled Propulsion/Steering System (V.A.P./S.) and other V/STOL, and/or thrust vectorable propulsion systems because the V.A.P./S System is a revolutionary departure rather than evolutionary, or variant in nature. In conventional thrust vectoring V/STOL systems there are many arrangements, yet represented within each is a common thread—that of venting and/or channeling whereby the jet thrust must, by necessity, lose force and escape velocity as the fluidity of the exhaust flow is deflected with vanes of some sort, or disrupted in the passage through ductwork, being neither direct, nor immediate, resulting in kinetic and thermogenic losses due largely to flow convection, conduction, and resistance by the inner surfaces of the ducts, tubes, channels, vanes, etc., as the exhaust makes its way to its ultimate point of exit.

Bearing this in mind, let us begin with those V/STOL jet propulsion systems utilizing venting methods. This general arrangement, whereby thrust is produced and redirected through means of deflection so as to apply the force of the jet thrust in more than one direction is typified in U.S. Pat. Nos. 4,000,854; 4,241,876; 5,390,877; 6,036,142; and 6,318,668 B1. The other commonly applied method of vectoring jet thrust is by way of channeling the jet thrust, which is produced in one location, and travels to another location where it would typically escape through a moveable exhaust outlet is typified in U.S. Pat. Nos. 3,986,687; 4,456,203; 4,587,804; 4,913,354; and 5,170,964. This method generally provides a wider variety of exhaust positioning and with more control than venting/deflecting, but the thrust is prone to even greater frictional and thermogenic losses, than would occur with venting, reducing power, escape velocity, and overall efficiency to an even greater extent. U.S. Pat. Nos. 4,358,074; and 5,769,317 are examples of how both methods are used together.

Another critical element missing in previous jet propulsion systems is the ability to simultaneously allocate available thrust in any ratio towards the functions of both steering and stabilization. The result of this deficiency is decreased maneuverability. The reason for this decreased maneuverability is forward momentum. If an aircraft traveling at a rapid rate attempted to suddenly and sharply change direction the accumulated force of momentum that had been an essential asset while propelling it from behind would become a potentially fatal liability as the momentum exerted its force against the aircraft's side (imagine the feeling that one receives in an automobile when turning too sharply at a high rate of speed, multiplied many times over, and without even the slight mitigating effect provided by a ground based suspension system). To prevent what would be an uncontrolled and violent tumble, current jet propulsion systems force the aircraft to first reduce speed, bank with ailerons and then raise elevators (even with the assistance of vectored thrust) bringing the aircraft about in a looping manner.

The speed and angle of the turn are further decreased due to the distant placement of the cockpit in relation to what would loosely be referred to as the axis of rotation (the tail assembly). The further an object is from the point of rotation, the faster it must travel relative to that point. The faster an object travels, the greater the gravitational forces generated and accordingly the impact therefrom. So bringing all of this together we currently have thrust vectoring propulsion systems that utilize kinetic and thermal energy inefficiently by virtue of the methodology employed, and force the aircraft to which they are applied to reduce speed, reorient the pilot in an unnatural sideways position, and loop through turns with the pilot in the worst possible position (with respect to “G” forces and also field of vision).

### SUMMARY OF THE INVENTION

The invention is illustrated in an aircraft characterized by a relatively low profile with no vertical stabilizer(s) and/or rudder(s) necessary and a fuselage of expanded width having a curvature from front to back and side to side, lending to the aircraft additional lift area as well as providing a very stable platform in order to compliment the dynamic performance of a Variably Angled Propulsion/Steering System (V.A.P./S.). The way the V.A.P./S System works is to bring all of the “raw” ingredients necessary to the production of jet/rocket thrust (compressed air and/or liquid oxygen, fuel, and means of ignition) separately to the point at which they will be utilized—the V.A.P./S. Burner Unit (11), which is itself both variably angled, via the V.A.P./S. Unit Extension Shaft (10), and fully rotatable. The result is unimpeded exhaust flow (more power) with undiminished thermal value (more escape velocity) applicable on any plane and in any direction. As this is accomplished without any sort of channeling (except for the Rear Exhaust Unit [FIGS. 5A, 5B] which is supplementary) or venting, power, speed, fuel efficiency and range would, therefore, be maximized. Further enhancing the efficiency of the Burner Unit(s) (11) and the Rear Exhaust Unit [FIGS. 5A, 5B] within the purview of the V.A.P./S. System, is a V.A.P./S. Unit Variable Area Exhaust Nozzle [FIG. 4] (38B), and a Rear Exhaust Unit Variable Area Exhaust Nozzle [FIGS. 5A, 5B] (43) which utilize the jet thrust in the most efficient way throughout every phase of operation. The V.A.P./S. System will apportion thrust, when turning, such that whatever counter-rotational torque is needed to neutralize momentum will be applied by virtue of the angling of its Extension Shafts (10) and the rotation of the Burner Units (11) [FIGS. 2A, 2B, 3].

The remainder of the thrust is applied towards redirection. Aiding in this endeavor is the remote lateral placement of its relatively light Burner Units (11) [FIGS. 1, 2A, 2B, 3] providing mechanical leverage against the largely centralized mass of the craft, as well as the Burner Units' Variable Area Exhaust Nozzle(s) [FIG. 4] (38B) which varies the combination of exhaust escape velocity versus exhaust escape mass in any ratio providing maximum speed during forward propulsion, and maximum power/torque during vertical takeoff/landing, braking, hovering, and sharply angled, high speed maneuvers.

The V.A.P./S. System, which utilizes the kinetic and thermal energy of the exhaust gasses more efficiently than current thrust vectoring systems, allows the aircraft to which it is applied to enter sharply angled maneuvers at high speed, and to further increase thrust output making more power available to redirection and stabilization and allowing the aircraft to accelerate through the maneuver while the pilot remains oriented in a fully level position and receiving the minimum “G” forces possible due to the placement of the Cockpit [FIG. 1](3). The decentralized configuration of the V.A.P./S. System, versus an identical arrangement, but where the entire engines are positioned in a similar manner as the V.A.P./S. Burner Units [FIG. 1] (11), is advantageous due to the lightweight nature of the V.A.P./S Burner Units (11) wherein the heaviest components necessary to the sustained production of jet thrust (turbine shaft(s) and blades, compressor shaft(s) and blades) are remotely located, closer to the Central Axis of Rotation [FIG. 3] (13), where there is greater structural support, providing a mechanical advantage in leverage with regards to steering and stabilization, as well as better balance, greater responsiveness, fewer maintenance issues, and therefore better overall performance, safety, and economy.

Also to be considered is the human tolerance of gravitational forces; It is one of the primary limiting factors in extreme maneuvering of aircraft in the context of manned flight.

G-forces on the pilot are minimized to their lowest practical level by positioning the Cockpit (3), and therefore the pilot, at the Central Axis of Rotation [FIG. 3] (13) where the rotational speed is its lowest with only a slight off-set so that the pilot can maintain spatial orientation. The off-set occurs as the pilot is so positioned that the balance mechanisms of the inner ear and brain are in line with the Central Axis of Rotation [FIG. 3] (13) and the eyes are just beyond it maximizing the benefits of the robust maneuverability provided by the V.A.P./S. System. Additionally, if low-orbit, trans-global deployment is to be part of the mission repertoire of a V.A.P./S. equipped aircraft, then a highly heat reflective/deflective coating/layer should be present, at the very least, on its underside in order to make re-entry feasible. It shouldn't be necessary to use heavy tiles because the speed, and attitude of re-entry can be controlled with the V.A.P./S. Burner Units in rocket mode.

The V.A.P./S. System is an independent, yet coordinated array of Burner Units (11) positioned, in one preferred embodiment, in a front-left, front-right, rear-left, rear-right configuration [FIG. 1]. The Burner Units (11) are each attached to the fuselage of an aircraft via the variably angled V.A.P./S. Unit Extension Shaft(s) (10) [FIGS. 1, 2A, 2B, 3], the angular setting of which is effected by the V.A.P./S. Angling Unit [FIGS. 8A-8C] (even during flight) which determines the proportion of jet/rocket thrust, produced by the Burner Unit(s) (11) [FIGS. 2A, 2B], allocated to steering versus stabilization during maneuvers. The variably angled V.A.P./S. Unit Extension Shaft (10), when combined with the fully rotatable Burner Unit (11), allows thrust to be vectored in any direction and on any plane [FIGS. 2A, 2B, 3]. Because the Burner Units (11) are offset from the central mass there is the additional mechanical advantage of leverage in neutralizing the destabilizing forces of momentum encountered during sharply angled, high speed maneuvers [FIGS. 2A, 2B, 3].

The Burner Units (11) receive a variable flow of compressed air [FIGS. 10, 11A], as determined by the primary CPU, produced by the Extended Length Primary Jet Engine(s) (4) [FIG. 1] which is able to divert much, if not most, of its compressor output to the Burner Units (11) via the V.A.P./S. Air Distribution Unit [FIGS. 11A, 1I B] and the V.A.P./S. Air Intake Feed [FIG. 10]. It is possible for the Extended Length Primary Engine(s) to do this and still maintain an effective power cycle because far more power than necessary to sustain its own power cycle is extracted by the extra sets of blades on its Turbine Shaft [FIG. 9A] (64). This extra power is utilized by the Turbine/Compressor Gearings [FIGS. 9A, 9B] which, via the Multiplying Gear(s) (66), Turbine Intermediate Gear (67), and the Compressor Gear (68) [FIGS. 9A, 9B], cause the Compressor Shaft (65) to revolve significantly faster than the Turbine Shaft (64) [FIG. 9A] producing far more compressed air faster than it would revolving at a 1:1 ratio. This excess compressed air is delivered to the V.A.P./S. Burner Units (12) where it is used to produce thrust that is more applicable to a wider array of functions than would be the case were it to be burned and vented by conventional jet power plants. The advantages to such an arrangement are as follows: (1) less negative torque is exerted against the aircraft during turning maneuvers; (2) significant quantities of compressed air become available for the production of thrust, within the Burner Units [FIG. 4] (11), where the thrust may be applied towards many performance enhancing functions such as integrated and variably proportioned steering/stabilization [FIGS. 2A, 2B, 3], vertical takeoff and landing and hovering [FIG. 6A], transitional and full propulsion [FIGS. 6B, 6C, 6D], and braking [FIGS. 7A, 7B, 7C, 7D, 7E].

The vast majority of the compressed air flowing into the Burner Unit(s) (11) is used to produce thrust, as would be expected, but a very small amount of that air is utilized to effect the production of electrical current locally, within each Burner Unit (11), via a small Turbine (22) which powers an Alternator or Generator (23), the current from which providing the energy to run all of the devices and mechanisms within each Burner Unit (11) requiring current [FIG. 4]. The major advantages to such an arrangement are as follows: 1. the elimination of the need for a hard-wire connection to the Fuselage [FIG. 1] (1) thus facilitating a complete range of motion by the V.A.P./S. Unit Extension Shaft (10) and the V.A.P./S Burner Unit (11); 2. the elimination of the need for regular maintenance and replacement of an extensive wiring arrangement for each Variably Angled Propulsion/Steering Unit (12); and 3. the elimination of the risk of premature interaction between the current and the air/oxygen and/or fuel supply (especially due to fraying of the wires) [FIG. 4]. Once within the Burner Unit (11) the compressed air is combined with fuel that is delivered by way of a Double-Walled Vacuum Fuel Line [FIG. 4] (37A) which when combined with the V.A.P./S. Fuel Line Joint [FIG. 13] (86) provides a leak-proof delivery system.

The mixture is then burned within the Combustion Chamber(s) [FIG. 4] (38) which are situated in proximity to the V.A.P./S. Variable Area Exhaust Nozzle (38B) [FIG. 4] such that the optimal balance of full combustion and maximal energy conservation is achieved, resulting in greater thrust and higher escape velocities (because the Burner Units (11) are fully rotatable and variably angled via the V.A.P./S. Unit Extension Shaft (10) [FIGS. 2A, 2B, 3,], thrust is immediate and direct as it may be vectored in any direction without channeling or venting.). Furthermore, the V.A.P./S. Exhaust Nozzle (38B) is variably sizeable due to an adjustable V.A.P./S Exhaust Piston (34) which further adds to the efficient utilization of the thrust in every possible situation much in the way a transmission would function [FIG. 4].

Supplemental to the V.A.P./S. Unit(s) (12) [FIG. 1], is the Rear Exhaust Unit [FIG. 1] (8), [FIGS. 5A, 5B] into which the expanding exhaust gasses from the Extended Length Primary Jet Engine(s) (4) [FIG. 1] flow, after having passed through all of the sets of turbine blades, yet still containing enough energy to assist in VTOL and STOL operations, flight mode propulsion, acute attitude adjustments, braking, and hovering completing the totality, when combined and coordinated within the V.A.P./S. System, of a full range of vectoring possibilities on every plane in infinite combinations. The Rear Exhaust Unit [FIG. 1] (8) is also equipped with a Rear Exhaust Unit Variable Area Exhaust Outlet (43), an Electrified Input Track (46), and a Feedback Track (45), the former supplying uninterrupted current and the latter providing constant two-way communications with the primary CPU, both throughout the full range of possible movements by the Rear Exhaust Unit [FIGS. 5A, 5B].

Added to all of the preceding is the capacity to replace compressed air with liquid oxygen via the V.A.P./S. Liquid Oxygen Feed Line [FIG. 4] (41) making low orbit, trans-global deployment a real possibility. Liquid Oxygen could also be fed into the Combustion Chambers (38) of the Burner Units (11) [FIG. 4], with the correct amount of additional fuel, supplementing the compressed air, for hyper-bursts of speed and power, if needed, to both attack opposing forces and evade incoming missiles. While most state of the art aircraft rely primarily on various forms of jamming and countermeasures to thwart these missiles, any suitable aircraft to which the V.A.P./S. System is applied, while possessing the same, would be even more survivable for the following reasons: 1. multiple exhaust sources each leaving different and constantly changing trails (a very effective built-in countermeasure in and of itself); 2. available hyper-speed wherein compressed air is supplemented with liquid oxygen; 3. the V.A.P./S Exhaust Piston [FIG. 4] (34) and the Rear Exhaust Piston [FIGS. 5A, 5B] (42) assists the V.A.P./S. System in accelerating any suitable craft to which it might be applied quickly and to great speeds; 4. the inherent ability of a suitable V.A.P./S. endowed aircraft to make near 90 degree turns at high speed and with complete stability. The result is aircraft that can hit without being hit which is the ideal standard for any combat aircraft.

Taking into consideration the limits of human endurance, the pilot is precisely positioned so as to be nearly at the Central Axis of Rotation (13) as is possible [FIG. 3] (the point at which rotation is slowest and gravitational forces are their lowest) with the balance centers of the inner-ear and brain aligned with the Central Axis of Rotation (13) and the eyes slightly off-set just enough so the pilot can perceive the turn and the extent of the turn.

Applications

The V.A.P./S. System is ideally suited to any aircraft where VTOL/STOL capabilities, and/or superior performance is advantageous such as, but not limited to, craft geared towards air to air combat, air to ground attack, frontline troop deployment and support, Med-Evacs, and even trans-global deployment, making the V.A.P./S. System far more versatile, and with far greater performance, than any version of the JSF or the F-22. In cases where extreme maneuvering on a great multiplicity of planes is not required, the V.A.P./S. System may be “stepped down” and simplified (especially with the removal of the V.A.P./S Extension Shaft) yet still maintaining the essence of the core design of the Burner Unit(s). Examples of such aircraft to which this solution would be ideal are large transports, reconnaissance aircraft, or even purely commercial aircraft needing nothing more than an efficient means to reduce the distance needed to takeoff and land ever increasingly large planes on runways that, in many airports, simply have no room in which to grow, and with the added advantage of increased speed, fuel efficiency, and range.

### BRIEF DESCRIPTION OF THE DRAWINGS

FIG. 1—V.A.P./S—(Top View); Two dimensional top plan view of the V.A.P./S System applied to a suitable aircraft.

FIG. 2A—Power Allocation: Steering vs. Stabilization—Straight; Two dimensional rear view depicting the placement of the V.A.P./S. Burner Units based on the angle of the Extension Shafts.

FIG. 2B—Power Allocation: Steering vs. Stabilization—Full Turn; Two dimensional rear view depicting the way in which the V.A.P./S. Burner Units allocate power during a full turn based on the angle of the Extension Shafts.

FIG. 3—V.A.P./S. Extreme Left Turn; Three dimensional top, rear view of the V.A.P./S. System facilitating a fully angled left turn. Burner Units rotate 90 degrees along an angular plane. Any angled turn between 1 and 90 degrees may be made.

FIG. 4—V.A.P./S. Unit (Cut Away); Two dimensional cut-away view of the V.A.P./S. Unit detailing the many internal parts that underlie its operation.

FIG. 5A—Rear Exhaust (Top); Two dimensional top view of the Rear Exhaust Unit detailing its internal and external components

FIG. 5B—Rear Exhaust (Side); Two dimensional side view of the Rear Exhaust Unit detailing its internal and external components

FIG. 6A—V.A.P./S VTOL Mode; Three dimensional view of the V.A.P./S. System with all of the Burner Units and the Rear Exhaust Unit vertically aligned for vertical take-off and landing.

FIG. 6B—V.A.P./S. Transitional Mode; Three dimensional view of the V.A.P./S. System making the transition from vertical take-off towards forward propulsion.

FIG. 6C—V.A.P./S. Flight Mode (Start); Three dimensional view of the V.A.P./S. System with all Burner Units and the Rear Exhaust Unit just beginning to apply all thrust towards forward flight.

FIG. 6D—Flight Mode (Full); Three dimensional side view of the V.A.P./S. System with all Burner Units ascended in the front and descended in the rear for normal flight operations.

FIG. 7A—V.A.P./S. Braking Start; Side view of the V.A.P./S. System with all Extension Shafts and Burner Units in the same position as in FIG. 6C, horizontally level to the aircraft's fuselage and wings as it begins the braking process.

FIG. 7B—V.A.P./S. Braking Stage 1; Side view of the V.A.P./S. System with front Burner Units and the Rear Exhaust Unit rotated 45 degrees in the same direction as they move through the braking process.

FIG. 7C—V.A.P./S. Braking Stage 2; As FIG. 7B continues to move further along both front Burner Units and the Rear Exhaust Unit are in a vertical position.

FIG. 7D—V.A.P./S. Braking Stage 3; Continuing from FIG. 7C, the front Burner Units continue to rotate in the same direction while the Rear Exhaust Unit reverses direction and rotates equally in the opposite direction.

FIG. 7E—V.A.P./S. Braking Stage 4; Side view of the V.A.P./S. System in the final braking position with the front Burner Units rotated 180 degrees and producing most of the thrust, and the Rear Exhaust Unit in its original starting position.

FIG. 8A—V.A.P./S. Angling Unit; Two dimensional, top view of a unit that adjusts the angle of the Extension Shafts and holds then locks them in place. Can be adjusted repeatedly during flight.

FIG. 8B—V.A.P./S. Angling Unit (G Feedback Nullified); Same as FIG. 8A showing the points at which force feedback, caused by downward gravity, is cancelled out.

FIG. 8C—V.A.P./S. Angling Unit (T Feedback Nullified); Same as FIG. 8A showing the points at which force feedback, caused by thrust, is cancelled out.

FIG. 9A—Turbine Compressor Gearings (Cut Away); Two dimensional cut-away view of the gearing setup that interfaces between the turbine shaft and the compressor shaft.

FIG. 9B—Turbine Compressor Gearings (Cross Section); Two dimensional cross sectional view of the gearing setup that interfaces between the turbine shaft and the compressor shaft.

FIG. 10—V.A.P./S. Air Intake Feed (Top View); Two dimensional top view of the cylinder that delivers compressed air to the V.A.P./S. Units and the apportioning valves.

FIG. 11A—Air Distribution Unit (Top); Two dimensional, top view of the system that collects and distributes compressed air produced by the main engines' compressors.

FIG. 11B—Air Distribution Unit (Cross Section); Two dimensional, cross sectional view of FIG. 11A.

FIG. 12A—Multi-Directional/Pivoting Control Unit (Counter-Clockwise); Two dimensional, top view of the Air Distribution Chamber with rotatable vents effecting adjustments while hovering. In this position as a portion of the compressed air is vented, the aircraft will rotate in a counter-clockwise direction.

FIG. 12B—Multi-Directional/Pivoting Control Unit (Left/Right); Same as FIG. 12A except that the vents are positioned for lateral adjustments rather than counter-clockwise rotation.

FIG. 12C—Multi-Directional/Pivoting Control Unit (Clockwise); Same as FIG. 12B except that the vents are positioned for clockwise rotation rather than lateral adjustments.

FIG. 13—Double-Walled Vacuum Fuel Line and Fuel Coupling (not to scale); Two dimensional, enlarged view of the Double-Walled Vacuum Fuel Line.

Complete descriptions of the figures are contained within each of the individual sections that follow.

### DETAILED DESCRIPTION OF PREFERRED EMBODIMENT

As is well known in the art, aircraft control is characterized by reference to three axes of rotation; the longitudinal or roll axis, the vertical or yaw axis, and the lateral or pitch axis. The precise location of each axis on the aircraft at a given point in time is a complex function of the center of lift or pressure acting in that axis, the center of mass, and the thrust moment of the aircraft thrust systems. The locations of these three axes are normally variable with aircraft configuration, loading, and instantaneous flight dynamics, but typically fall each within its respective, predictable, limited range for the normal flight envelope of the aircraft.

By design of an aircraft, it can be arranged that the three ranges substantially intersect so as to define a nominal center of rotation where acceleration due to rotation of the aircraft in any axis is minimal. However, the invention contemplates the availability and use of asymmetrical and variable direction thrust control, providing the required thrust moment for maintaining a tightly controlled center of rotation while at the same time executing more extreme flight maneuvers.

The V.A.P./S. System may possess a number of sub-systems which collectively enable the overall function of the V.A.P./S. System and are therefore to be considered as part of the overall V.A.P./S. System. They are disclosed and described within the following sections.

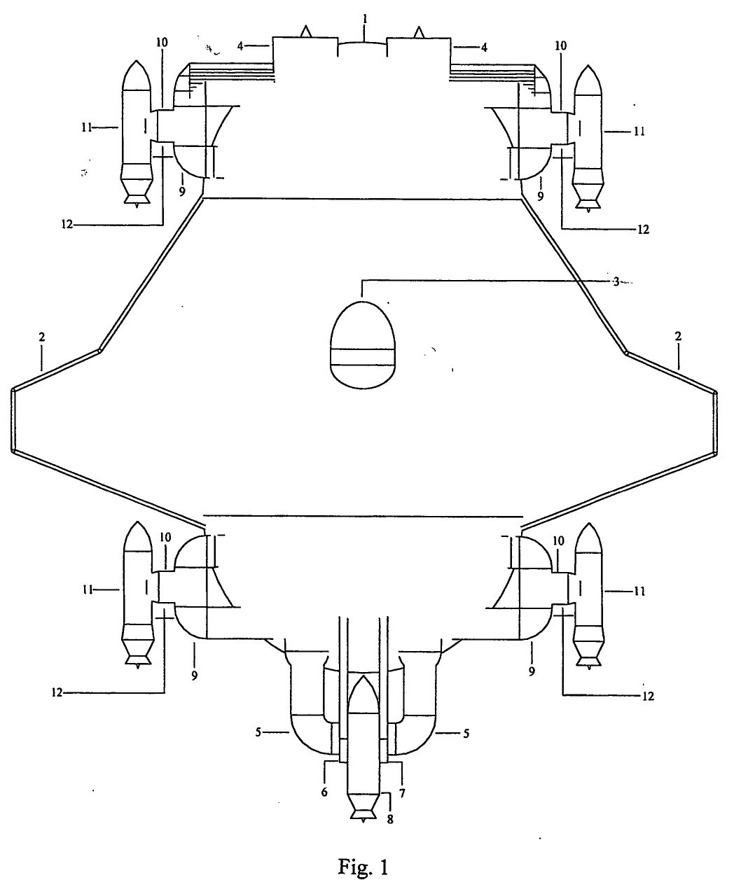

FIG. 1-V.A.P./S System—(Top View)

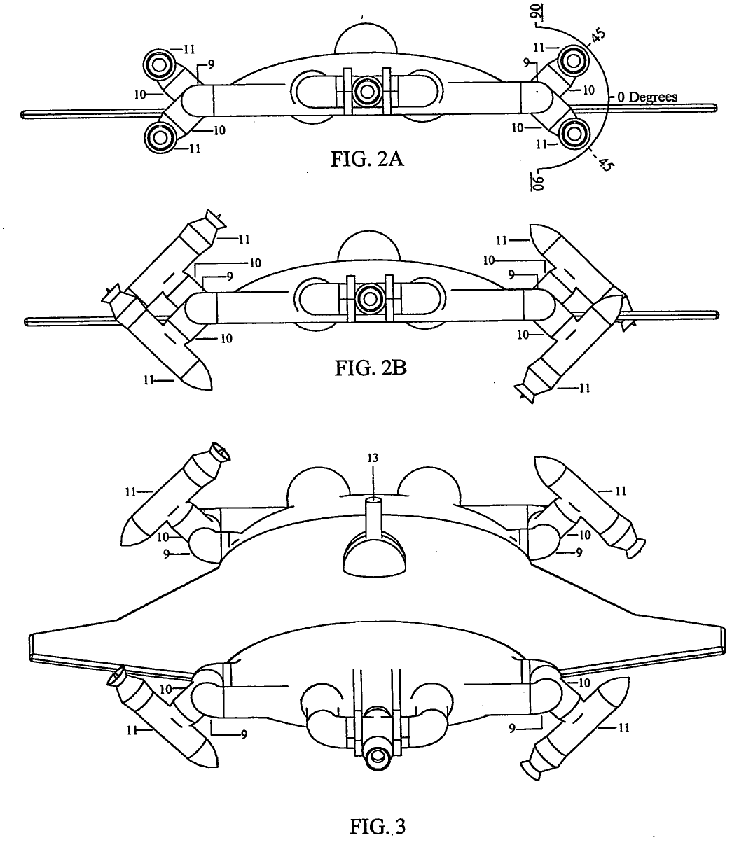

Fuselage—being wider than normal with a largely flat underside and a topside with a longitudinal curvature extending from front to back and lateral curvature extending from side to side, it provides extra lift area while reducing turbulent airflow. #1
Wing (with aileron) #2
Cockpit—located at the Central Axis of Rotation, the pilot is positioned so that the balance centers of the inner ear and brain are as closely aligned as is possible with the Central Axis of Rotation causing the eyes to be slightly offset so that gravitational forces upon the pilot resulting from sharply angled, high speed maneuvers are minimized while the ability to perceive the turn and the extent thereof are preserved. #3
Extended Length Primary Jet Engine—extends the full length of the aircraft to accommodate extra sets of turbine blades so that more power is available to drive extra sets of compressor blades which are connected to the drive shaft via multiplying gears which cause the compressor blades to spin more than once for every revolution of the drive shaft. This facilitates an increased air supply which is diverted to the Air Distribution Chamber which supplies the V.A.P./S. Burner Units with compressed air. #4
Jet Engine Exhaust Feed—even after the rapidly expanding gasses pass through the extra sets of turbine blades, there will still be significant thrust available for the Rear Exhaust Unit to effect propulsion, climbing, and diving, and to assist in VTOL/STOL operations. This makes elevators unnecessary, though it may be desirable to include them if they can be shown to compliment the attitude adjustment of the aircraft. #5
Rear Exhaust Unit Feedback Track—this interface allows the Rear Exhaust Unit to rotate while maintaining constant communications with the CPU. The CPU is able to know the position of the Exhaust Piston due to a sensor placed in contact with the Exhaust Piston Rack. A signal is then returned to a switch through which electrical current from the Rear Exhaust Unit Electrical Input Track must pass. The switch will route the current to the Rear Exhaust Unit's electrical motor so that it will cause the actuating gear to spin in either direction thus effectively and immediately causing the Exhaust Piston (and therefore exhaust nozzle volume) to be adjusted as needed. #6
Rear Exhaust Unit Electrical Input Track—this interface allows the Rear Exhaust Unit to rotate while receiving an uninterrupted power supply of electrical current to power its electrical motor. #7
Rear Exhaust Unit—after passing through an extended set of turbine blades, the combustion gasses are channeled into this rotatable unit that assists in propulsion, climbing, diving, braking, hovering and VTOL/STOL operations. Thrust is adjustable because the CPU calculates and regulates the amount of compressed air and fuel burned in the jet engines' combustion chambers to fit the situation at hand. #8
V.A.P./S. Unit Base—securely attached to the fuselage, it is the two point pathway through which the power from the Burner Unit's jet/rocket thrust is passed on to the rest of the aircraft where it will be used to lift, propel, steer, stabilize, brake, hover, and land. Different shapes/fittings may be employed to various parts of the V.A.P./S. Unit Base to reduce drag. #9
V.A.P./S. Unit Extension Shaft—the angle at which it is set determines the proportion of thrust, produced within the Burner Unit, allocated to steering and stabilization when maneuvers are made. The angle may be adjusted, in flight, as total mass and speed change. Different shapes/fittings may be employed to various parts of the V.A.P./S. Extension Shaft to reduce drag. The shape modifications may be fixed, or may rotate along with the Burner Unit. Front and/or trailing edge tapering would be one possibility. #10
V.A.P./S. Jet/Rocket Burner Unit—compressed air (and/or liquid oxygen) and fuel are delivered separately and then mixed in the V.A.P./S. Burner Unit where it is ignited, thereby producing the jet thrust that lifts, propels, steers, stabilizes, brakes, and lands the aircraft. While capable of revolving in any direction, depending on what function is desired, during flight mode, though all four units rotate on different planes, movement is simultaneous and equivalent. Thrust is also variable because the CPU constantly calculates and regulates the total amount of compressed air (and/or liquid oxygen) available to all of the V.A.P./S. Burner Units, collectively, and further distributes between the front set and the rear set as needed. Fuel amounts are simultaneously delivered in the appropriate ratios. The exhaust outlets of the Burner Units are adjustable such that the speed and volume of the escaping gasses are also variable depending upon the particular operation desired. #11
V.A.P./S. Unit—is comprised of the V.A.P./S. Unit Base, V.A.P./S. Unit Extension Shaft, and the V.A.P./S. Jet/Rocket Burner Unit. #12
   Power Allocation: Steering vs. Stabilization
   FIG. 2A-Power Allocation: Steering vs. Stabilization—Straight/Full Turn
   FIG. 2B-Power Allocation: Steering vs. Stabilization—Full Turn

The Variably Angled Propulsion/Steering System (V.A.P./S.) is predicated upon a simple concept: the power generated by the engine(s) can and should be used to do more than just propel the craft forward. In conventional modern aircraft design, this is the only function an engine, and the thrust therefrom, serves. When a change of direction is required, the method by which this is accomplished has remained essentially unchanged using a combination of ailerons, rudder(s), and elevator(s) which rely solely on the passive manipulation of air flow. Even so-called thrust vectoring propulsion systems as would be found on the F-22, or SU-37 vector thrust along only one plane of motion and would play no role in counteracting the destabilizing forces of momentum upon an aircraft during sharply angled, high-speed maneuvers were such maneuvers to even be possible with these systems. During this process of redirection the formidable force of momentum (mass×speed) in addition to the ongoing uni-directional thrust of the engine(s) must be taken into account as they are both working in opposition to any sort of redirection. The more effectively we can counter and negate these great physical forces, the more maneuverable the aircraft becomes. In a military context, this becomes a matter of life and death—victory and defeat! Would it stand to reason that a more maneuverable aircraft is a more survivable aircraft? So now the question becomes, “How to produce a more maneuverable aircraft?”

We must first ask ourselves, “What is the greatest force that a jet aircraft has available to in some way actively mitigate the destabilizing forces of momentum levied against the aircraft as it attempts to change direction?” If we adopt the conventional wisdom the answer would be drag (friction) and pressure differential. Now stop and think; if that was such a potent force, “Why not use it to propel the craft in the first place?” The answer is simple; drag and pressure differential are not generative forces, but rather associative forces. That is to say that they exist only by gently “tapping into” an existing generative force—in this case momentum. As stated earlier, momentum is the product of mass and speed. Without a force to generate speed, the aircraft will not fly, nor will it turn. It should be clear that drag and pressure differential are not the greatest forces available. I'm quite sure that you had already reasoned as much. I'd also venture to say that you have figured out what is the greatest force an aircraft has available to it. Now the question becomes, “How to most effectively harness the power of jet thrust?” This brings us squarely to the essence of the V.A.P./S.}

The Variably Angled Propulsion/Steering System (V.A.P./S.) is predicated upon a simple concept: the power generated by the engine(s) can and should be used to do more than just propel the craft forward. This decentralized yet coordinated array of units produce thrust which is vectorable on an infinite number of planes (when combined with the Rear Exhaust Unit) thus providing integrated and seamless propulsion, steering, and stabilization of the aircraft, as well as hovering, braking and vertical (or short) take-off and landing.

The Burner Units, which house the combustion chambers (the source of the thrust), are fully rotatable along variable, changeable planes ranging from parallel to perpendicular. The incline, or decline, of the V.A.P./S. Unit Extension Shaft (depending on whether the V.A.P./S. Unit is located towards the front, or back of the aircraft) determines the plane of rotation of the Burner Unit. In FIG. 2A and FIG. 2B a 0 degree positioning of the V.A.P./S. Extension Shaft represents a perpendicular plane of Burner Unit rotation. If all (in this case four) of the V.A.P./S. Extension Shafts were to be in this position during flight mode, 100% of the available jet thrust would be applied towards stabilization during maneuvers. In the same illustration+ or −90 degrees (depending on whether the V.A.P./S. Unit is located towards the front, or back of the aircraft) represents a parallel plane of Burner Unit rotation. If all of the V.A.P./S. Extension Shafts were to be in this position, 100% of the available jet thrust would be applied towards steering (redirection). In FIG. 2A and FIG. 2B the Extension Shafts are set at 45 degrees (plus and minus, respectively) whereby equal amounts of thrust are applied towards both steering and stabilization, however, any setting between 0 degrees and + or −90 degrees is possible. We now have the two essential ingredients in place—the ability to apply the precise proportion of jet thrust needed towards 1) redirecting the aircraft, and 2) stabilizing the aircraft against the resulting forces of momentum. *Changes in the angle of the V.A.P./S. Unit Extension Shaft can be made in flight, as the variables of mass and speed change, as long as the Burner Unit(s) is completely straight during such adjustments.

Comparisons:

Conventional Jet Propulsion Systems—apply thrust in only one direction (forward propulsion); no steering capacity; no stabilization capacity.

Limited Thrust Vectoring Systems (F-22; SU-37)—apply thrust towards forward propulsion and assists in vertical attitude adjustment only; no stabilization capacity. V.A.P./S. System—applies thrust in any direction, and on any plane thus facilitating vertical take-off and landing and attitude adjustment (with the addition of the Rear Exhaust Unit), hovering, and braking, as well as forward propulsion, steering, and integrated stabilization such that no additional measures are necessary during sharply angled, high-speed maneuvers provided the Extension Shafts are set at an appropriate angle; the rotation of the Burner Units will temporarily eliminate the continuation of forward thrust while applying variable proportions of thrust to both steering and stabilization until the maneuver is complete, at which time forward propulsion (or any other function) may resume.

### Conclusions

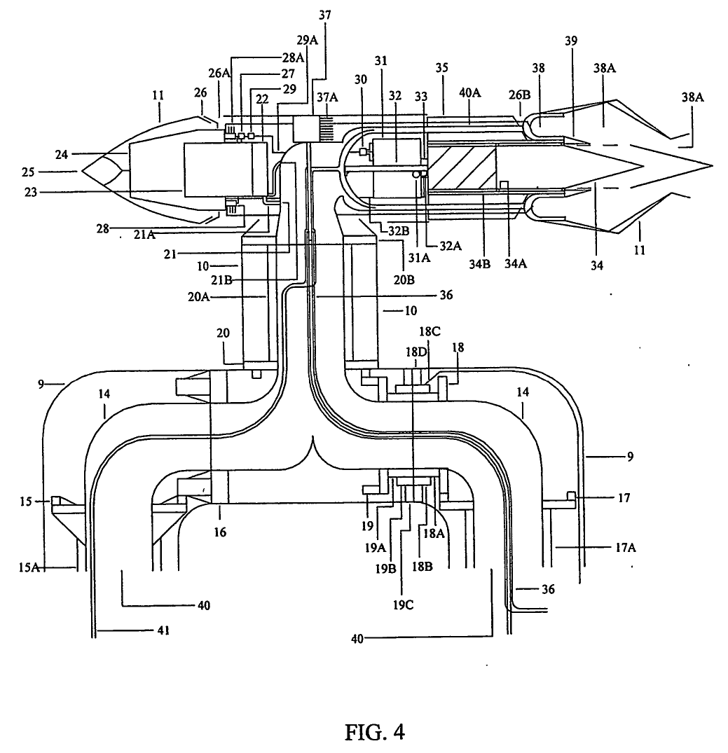

The V.A.P./S. System (applied to suitable aircraft) will enable more versatile, deployable, and maneuverable aircraft equipped than any other propulsion system making it more useful tactically and strategically, and any suitable aircraft to which it would be applied more survivable preserving both lives and material resources.
V.A.P./S. Unit Base #9
V.A.P./S. Unit Extension Shaft #10
V.A.P./S. Jet/Rocket Burner Unit #11
   V.A.P./S. Extreme Turning
   FIG. 3-V.A.P./S. Extreme Left Turn
V.A.P./S. Unit Base #9
V.A.P./S. Unit Extension Shaft #10
V.A.P./S. Jet/Rocket Burner Unit #11
Central Axis of Rotation—a point that is halfway between the port and starboard boundaries of the fuselage, and halfway between the front and rear V.A.P./S. Units. #13
   An extreme turn may be performed in the following manner:

Both front V.A.P./S. Burner Units revolve 90 degrees in the same direction as one another, but on different planes and at the same rate.

Simultaneously both rear V.A.P./S. Burner Units revolve in the same direction as one another (in the opposite direction as the two front V.A.P./S. Burner Units), but on different planes and at the same rate.

This procedure will cause the aircraft to rotate on its Central Axis. A correct angular setting of the V.A.P./S. Extension Shafts will allocate sufficient thrust to counteract destabilizing forces while the turn is being completed. The aircraft should rotate slightly beyond the intended direction at which point all of the V.A.P./S. Burner Units will briefly straighten so that the thrust of all of the V.A.P./S Burner Units, as well as the Rear Exhaust Unit, will directly oppose the force of momentum thus reducing slip angle. A very slight correction, whereby the V.A.P./S. Burner Units are very quickly and slightly rotated opposite the initial direction of rotation should be made at a point where the slippage has ceased. The V.A.P./S. Burner Units should then immediately return to full propulsion mode. When this maneuver is well practiced and well executed, the aircraft will be capable of near 90 degree turns. The placement of the Cockpit is such that the pilot is almost precisely aligned with the Central Axis of Rotation thus drastically reducing gravitational forces against the pilot while maintaining the perception that a turn has been made and to what extent.

V.A.P./S. Unit

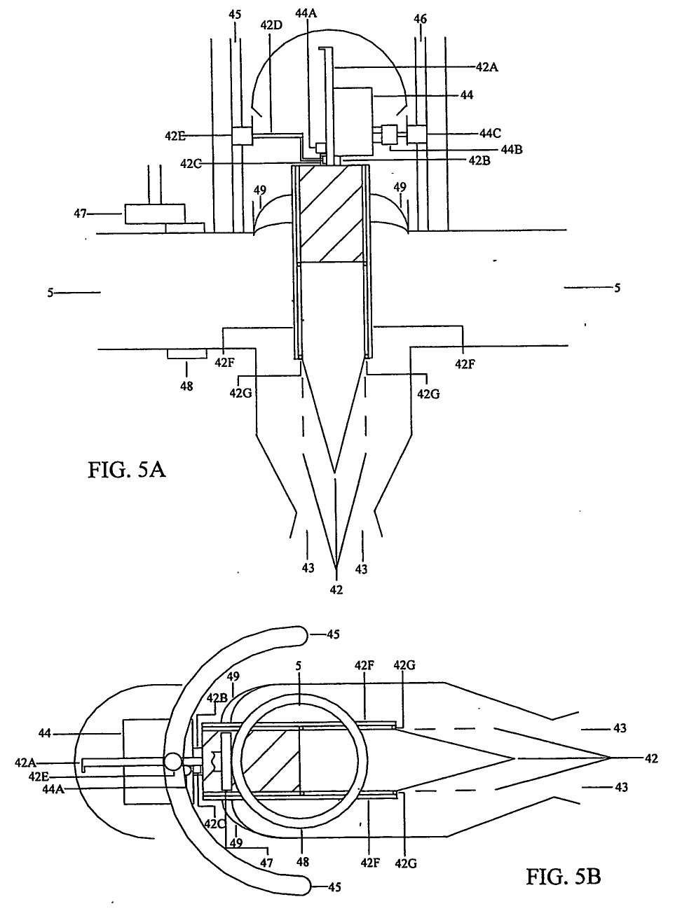

FIG. 4-V.A.P./S. Unit (Cut-Away)

V.A.P./S. Unit Base #9
V.A.P./S. Unit Extension Shaft #10
V.A.P./S. Jet/Rocket Burner Unit #11
V.A.P./S. Compressed Air Conduit #14
V.A.P./S. Extension Shaft Angling Gear #15
V.A.P./S. Extension Shaft Angling Gear Linkage #15A
V.A.P./S. Extension Shaft Receptor Gear—attached to V.A.P./S. Outer Hull, but not to Compressed Air Conduit. #16
V.A.P./S. Jet/Rocket Burner Unit Steering Gear #17
V.A.P./S. Jet/Rocket Burner Unit Steering Gear Shaft #17A
V.A.P./S. Jet/Rocket Burner Unit Steering Receptor Gear #18
V.A.P./S. Jet/Rocket Burner Unit Steering Receptor Gear Shaft #18A
V.A.P./S. Jet/Rocket Burner Unit Electromagnetic Actuating Gear—the purpose here is to allow the V.A.P./S. Extension Shaft to change its angle, and therefore the ratio of power allocated to propulsion and steering, without affecting the linkage responsible for the rotation of the V.A.P./S. Jet/Rocket Burner Unit. This is feasible because all systems are routed through either the primary C.P.U., or the local V.A.P./S. Jet/Rocket Burner Unit C.P.U.'s. In this instance both steering and angular adjustments would be overseen by the primary C.P.U. which would be programmed to halt electrical current to this gear when the V.A.P./S. Extension Shaft is making adjustments so that the V.A.P./S. Jet/Rocket Burner Unit Electromagnetic Receptor Gear would be able to “slip” freely without affecting the linkage that rotates the V.A.P./S. Jet/Rocket Burner Unit. Once the V.A.P./S. Extension Shaft adjustment is complete the electrical current sent to the V.A.P./S. Jet/Rocket Burner Unit Electromagnetic Actuating Gear is resumed so that steering is again enabled. *The Burner Unit(s) must be positioned for straight flight before the angular setting of the V.A.P./S. Extension Shaft can be changed. When the adjustment is complete, the Burner Unit(s) may, once again, move freely. #18B
Electromagnetic Actuating Gear Feed Line—delivers electrical current to the V.A.P./S. Jet/Rocket Burner Unit Electromagnetic Actuating Gear. #18C
V.A.P./S. Jet/Rocket Burner Unit Electromagnetic Actuating Gear Guide #18D
V.A.P./S. Jet/Rocket Burner Unit Intermediate Gear 1. #19
V.A.P./S. Jet/Rocket Burner Unit Electromagnetic Receptor Gear Shaft #19A
V.A.P./S. Jet/Rocket Burner Unit Electromagnetic Receptor Gear #19B
V.A.P./S. Jet/Rocket Burner Unit Electromagnetic Receptor Gear Guide #19C
V.A.P./S. Jet/Rocket Burner Unit Intermediate Gear 2. #20
V.A.P./S. Jet/Rocket Burner Unit Intermediate Gear 2 Shaft #20A
V.A.P./S. Jet/Rocket Burner Unit End Gear #20B
V.A.P./S. Compressed Air Conduit Turbine Outlet—a very small amount of the compressed air is diverted to drive the V.A.P./S. Burner Unit Turbine that powers the V.A.P./S. Burner Unit Alternator/Generator. #21
V.A.P./S. Compressed Air Conduit Turbine Feed—segway through which compressed air enters and drives the V.A.P./S. Burner Unit Turbine at the end of which is placed a pressure regulator so that the electrical output within the Burner Unit(s) remains steady as the amount of compressed air flowing through the V.A.P./S. Compressed Air Conduit varies. #21A
V.A.P./S. Compressed Air Return Feed—“Extra” air bypassing the V.A.P./S. Burner Unit Turbine is reintegrated into the main flow of compressed air. #21B
V.A.P./S. Burner Unit Turbine—revolving, compressed air driven turbine blades drive the
V.A.P./S. Burner Unit Alternator/Generator. #22
V.A.P./S. Burner Unit Alternator/Generator—provides power for various components within the V.A.P./S. Burner Unit such as the C.P.U., Exhaust Piston Motor, feedback sensors, injectors, and the igniting element for the V.A.P./S. Combustion Chamber during start-up. An auxiliary battery, to be used when the Burner Unit is in rocket mode, is integrated so that it will always remain fully charged when not in use. #23
V.A.P./S. Burner Unit C.P.U.—controls those functions local to the V.A.P./S. Burner Unit such as electrical current routing, and Exhaust Piston positioning based upon sensory feedback and programming. #24
V.A.P./S. Burner Unit Speed Sensor—provides the C.P.U. with the current velocity of the aircraft so that the C.P.U. may use that factor to help determine the optimal positioning for the Exhaust Piston and the V.A.P./S. Extension Shaft. #25
V.A.P./S. Burner Unit C.P.U. Deflected Cooling Vent—inlet for air to cool the C.P.U. in a tempered manner. #26
V.A.P./S. Burner Unit Cooling Vent Inlet—helps to dissipate heat conducted to the Exhaust Piston Cylinder Cooling Fins from the Exhaust Piston Cylinder. #26A
V.A.P./S. Burner Unit Cooling Vent Outlet #26B
V.A.P./S. Burner Unit Generator Routing Switch—through communication with the C.P.U. this switch directs electrical current from the V.A.P./S. Burner Unit Alternator/Generator to the Exhaust Piston Motor, V.A.P./S. Burner Unit Combustion Chamber Electrical Hub, sensors and the CP.U. itself. #27
V.A.P./S. Burner Unit Combustion Chamber Electrical Hub—serves as a relay through which the V.A.P./S. Burner Unit Combustion Chamber Electrical Feed Line(s) deliver current to the igniting element within the V.A.P./S. Combustion Chamber. #28
V.A.P./S. Burner Unit Combustion Chamber Electrical Feed Line(s)—deliver current to the igniting element within the V.A.P./S. Combustion Chamber. #28A
Exhaust Piston Motor Relay—receives electrical current from the V.A.P./S. Burner Unit Generator via the V.A.P./S. Burner Unit Alternator/Generator Routing Switch. #29
Exhaust Piston Motor Relay Line—delivers electrical current to the Exhaust Piston Motor Relay Switch. #29A
Exhaust Piston Motor Relay Switch—as directed by the C.P.U., electrical current may flow to one of three channels—outward, stop, and inward so that the Exhaust Piston may be positioned properly. When electrical current is directed towards either outward or inward, it must first pass through the stop channel at which point a brake is applied before current is redirected to the opposite channel. This allows the Exhaust Piston Motor Output Gear to very briefly stop before reversing its direction of rotation. If the reversing of the Exhaust Piston Motor Output Gear can be effectively accomplished without braking and stopping, and done so in a sustained manner, then the intermediate stop channel may be eliminated. #30
Exhaust Piston Motor—operates the Exhaust Piston Motor Output Gear in both directions of rotation. #31
V.A.P./S Exhaust Piston Motor Output Gear—actuates the Exhaust Piston Rack to which the Exhaust Piston is attached. #31A
V.A.P./S Exhaust Piston Rack—as it is moved inward and outward by the Exhaust Piston Motor Output Gear, so to is the Exhaust Piston. #32
V.A.P./S Exhaust Piston Rack Sensor—provides the C.P.U. with the precise positioning of the Exhaust Piston Rack (and therefore the Exhaust Piston) so that adjustments made to the Exhaust Piston are made relative to its current position. #32A
V.A.P./S Exhaust Piston Rack Sensor Feedback Line—the means by which feedback from the Exhaust Piston Rack Sensor is transmitted to the C.P.U. #32B
V.A.P./S Exhaust Piston Rack Guide #33
V.A.P./S Exhaust Piston—the area of the V.A.P./S. Exhaust Nozzle is varied according to the position of the Exhaust Piston enabling the manipulation of thrust. Hatched area (the part that remains within the Exhaust Piston Cylinder at all times) is more dense than the unhatched area of the Exhaust Piston to provide a favorable balance when the Exhaust Piston is fully extended. #34
V.A.P./S Exhaust Piston Bearings—facilitates the smooth back and forth passage of the Exhaust Piston within the Exhaust Piston Cylinder. #34A
V.A.P./S Exhaust Piston Cylinder—housing in which the Exhaust Piston resides. #34B
V.A.P./S Exhaust Piston Cylinder Cooling Fins—transfers heat from the Exhaust Piston Cylinder so that it may be vented by the flow through of air. #35
V.A.P./S. Double Walled Vacuum Return Fuel Line—fuel flows through the inner tubing while a vacuum leading back to the fuel tank exists between the inner and outer tubing to eliminate the possibility of leakage into the V.A.P./S. Compressed Air Conduit. #36
V.A.P./S. Burner Unit Fuel Reservoir—provides a convenient means by which the fuel supply may be disbursed to the multiple V.A.P./S. Combustion Chamber Fuel Lines. #37
V.A.P./S. Double Walled Vacuum Fuel Line(s)—delivers fuel to the V.A.P./S.

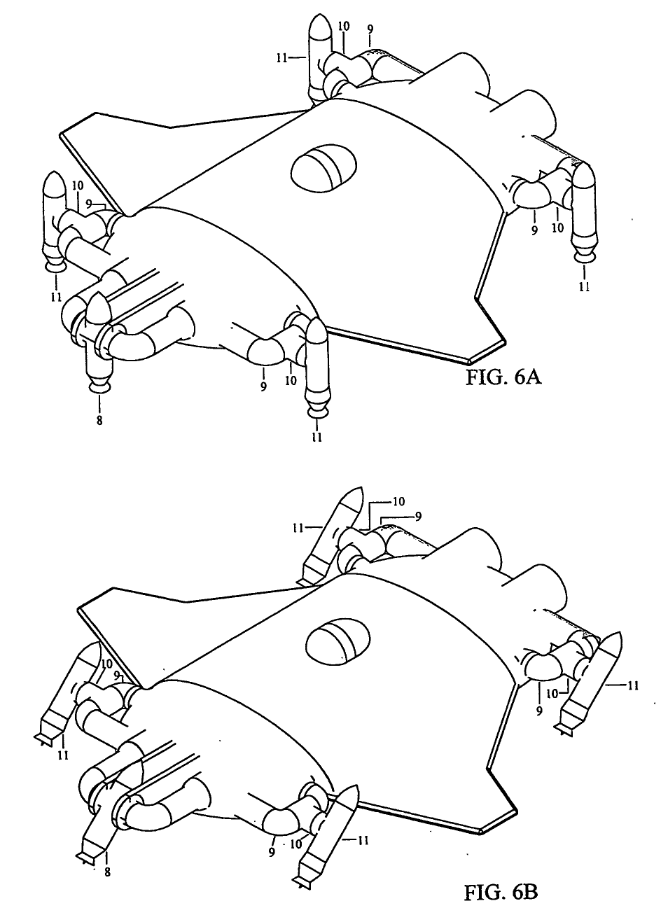

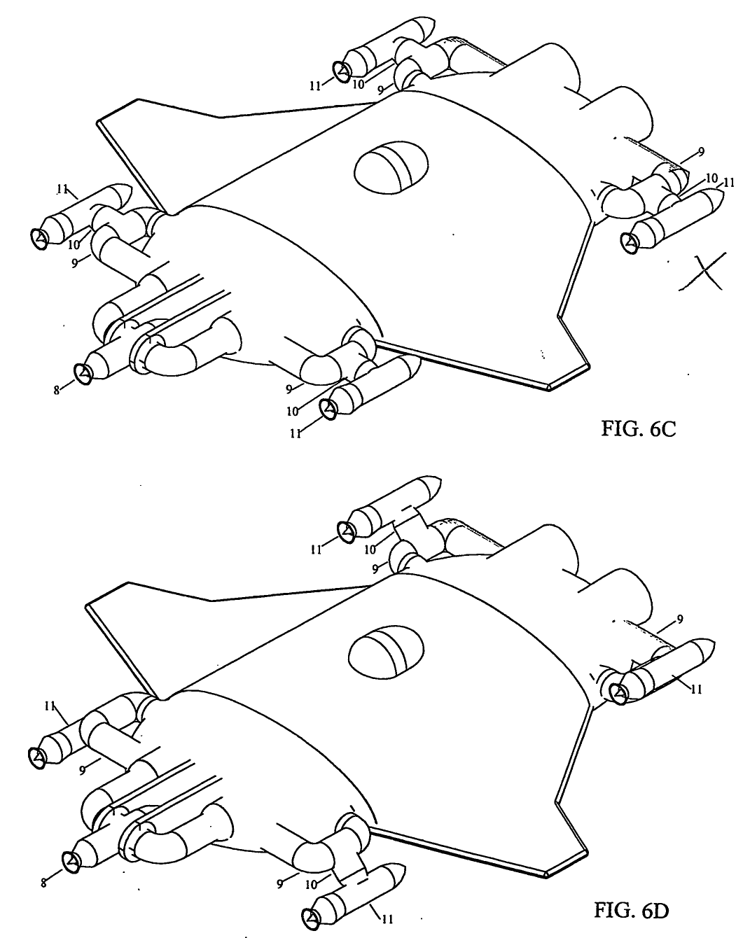

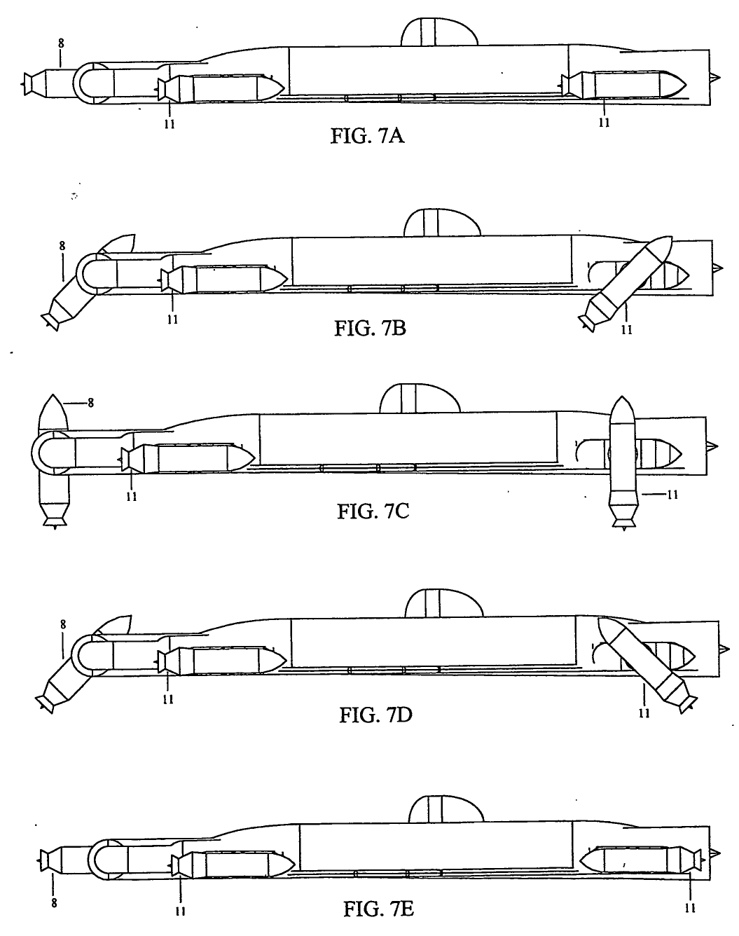

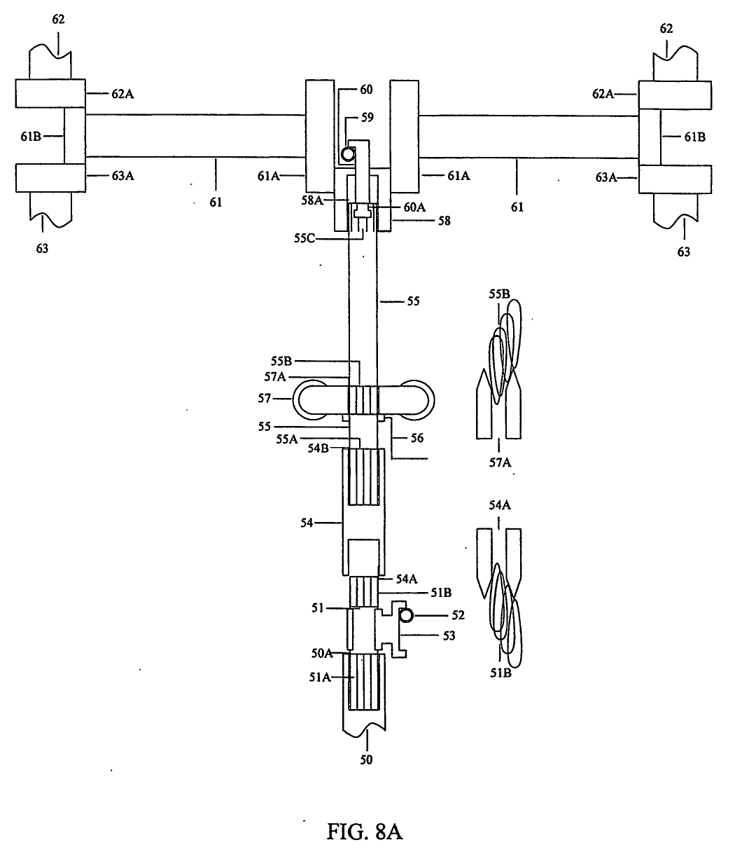

Combustion Chamber. #37A
V.A.P./S. Combustion Chamber—fuel is mixed and burned with compressed air in jet mode, liquid oxygen in rocket mode, or compressed air supplemented by liquid oxygen for super bursts of speed and power, further enhancing the hyper-agility the V.A.P./S. System provides to aircraft to which it is applied. *The hybrid nature of this combustion process would enable this aircraft to climb to the upper atmospheric layer in jet mode, exit the atmosphere and enter a low orbit in rocket mode, and travel to the opposite side of the planet in a fraction of the time it would have taken otherwise, thus dramatically increasing the ability to project power in a crisis. #38
V.A.P./S. Combustion Chamber—Lower #38A
V.A.P./S. Unit Variable Area Exhaust Nozzle—the exhaust escape area is varied with the extension and retraction of the Exhaust Piston. #38B
V.A.P./S. Combustion Chamber Expansion Gas Deflector #39
V.A.P./S. Compressed Air Conduit Inlet #40
V.A.P./S. Combustion Chamber Compressed Air Feed #40A
V.A.P./S. Liquid Oxygen Feed Line #41
   REAR Exhaust Unit
   FIG. 5A-Rear Exhaust Unit (Top Cut-Away)
   FIG. 5B-Rear Exhaust Unit (Side Cut-Away)
Jet Engine Exhaust Feed—After the exhaust gasses from both main engines have passed through their own turbine blades they are directed into the Rear Exhaust Unit where the remaining unused power is used to assist in VTOL/STOL operations, propel the aircraft, brake, and supplement or replace the elevator as this unit rotates up and down for attitude adjustment. #5
Rear Exhaust Piston—the placement of which allows for the manipulation of the escaping exhaust gasses. Hatched area (the part that remains within the Rear Exhaust Piston Cylinder at all times) is more dense than the unhatched area of the Rear Exhaust Piston to provide a favorable balance when the Rear Exhaust Piston is fully extended. #42
Rear Exhaust Piston Rack—attached to the Rear Exhaust Piston, it is actuated by the Rear Exhaust Unit Motor Output Gear. #42A
Rear Exhaust Piston Rack Guide #42B
Rear Exhaust Piston Rack Sensor—provides feedback to the main C.P.U. so that all adjustments to the Rear Exhaust Piston take into account its current position. #42C
Rear Exhaust Piston Rack Sensor Feedback Line—sends and receives sensory feedback information to and from the primary CPU via the Rear Exhaust Piston Rack Sensor Feedback Roller. #42D
Rear Exhaust Piston Rack Sensor Feedback Roller—sends and receives uninterrupted sensory feedback information to and from the main C.P.U. regardless of movements by the Rear Exhaust Unit itself. #42E
Rear Exhaust Piston Cylinder #42F
Rear Exhaust Piston Cylinder Ball Bearings—completely encircle Rear Exhaust Piston, front and back, to facilitate smoother back and forth passage of the Exhaust Piston. #42G
Rear Exhaust Unit Variable Area Exhaust Outlet #43
Rear Exhaust Unit Motor—drives the Rear Exhaust Unit Motor Output Gear. #44
Rear Exhaust Unit Motor Output Gear—adjusts the position of the Rear Exhaust Piston Rack and therefore the Rear Exhaust Piston. #44A
Rear Exhaust Unit Motor Relay Switch—receives instructions from the main CPU via the Rear Exhaust Piston Rack Sensor Feedback Roller and routes electrical current to one of three channels which feed the Rear Exhaust Unit Motor (clockwise rotation, off/brake, counter-clockwise rotation). *The off/brake channel may be eliminated if tests show that mechanical reliability and longevity are not compromised. #44B
Rear Exhaust Unit Motor Electrical Receptor—delivers electrical current from the Rear Exhaust Unit Electrified Track to the Rear Exhaust Unit Motor Relay Switch. #44C
Rear Exhaust Unit Feedback Track—allows for a continuous flow of sensory feedback to and from the main C.P.U. as the Rear Exhaust Unit rotates up and down. #45
Rear Exhaust Unit Electrified Track—allows for a continuous flow of electrical current to the Rear Exhaust Unit Motor as the Rear Exhaust Unit rotates up and down. #46
Rear Exhaust Unit Adjuster Gear—initiates the upward and downward rotation of the Rear Exhaust Unit Receptor Gear. #47
Rear Exhaust Unit Receptor Gear—effects the upward and downward rotation of the Rear Exhaust Unit. #48
Rear Exhaust Unit Vacuum—heat barrier. #49
   V.A.P./S. Flight Modes
   FIG. 6A-V.A.P./S VTOL Mode—the aircraft begins in Vertical Take-Off and Landing mode. It may be desirable to equip the aircraft with landing gear which may be utilized when a vertical take-off, or vertical landing are not required. This will save fuel extending the aircraft's range, but more importantly will enable a heavier than normal payload. When landing, after the target landing area has been reached with the Rear Exhaust Unit and all four of the V.A.P./S. Burner Units aligned vertically, exhaust nozzles pointed downwards, thrust is gradually reduced such that the aircraft will begin a controlled descent. The CPU will apportion air and fuel so that the appropriate balance in thrust is maintained for a quick, controlled descent. Should minor positioning adjustments be desired during descent the Lateral/Pivoting Control System will vent a small portion of the compressed air within the Air Distribution Chamber in the appropriate direction until the desired adjustment is complete.
   FIG. 6B-V.A.P./S. Transitional Mode—once an adequate altitude has been attained, the V.A.P./S. Burner Units and the Rear Exhaust Unit begin to rotate such that they are both lifting and propelling the aircraft forward.
   FIG. 6C-V.A.P./S. Flight Mode [Start]—once an adequate speed has been attained, the V.A.P./S. Burner Units and the Rear Exhaust Unit continue to rotate until they are parallel to the body of the aircraft and are propelling the aircraft forward.
   FIG. 6D-V.A.P./S. Flight Mode [Full]—at the moment the V.A.P./S. Burner Units reach Flight Mode [Start] position, the V.A.P./S. Unit Extension Shafts begin to ascend in the front, and descend in the rear to an optimal, matching angle (see diagram Power Allocation: Steering vs. Stabilization).
Rear Exhaust Unit #8
V.A.P./S. Unit Base #9
V.A.P./S. Unit Extension Shaft #10
V.A.P./S. Jet/Rocket Burner Unit #11
   V.A.P./S. Braking Procedure
   FIG. 7A-V.A.P./S. Braking Start—From full flight mode, the V.A.P./S. Unit Extension Shafts readjust position to the same plane as the body of the aircraft (0 degrees; see FIG. 2A) while the V.A.P./S. Burner Units continue to propel the aircraft in a straight, forward path.
   FIG. 7B-V.A.P./S. Braking Stage 1—once the V.A.P./S. Unit Extension Shafts readjust to 0 degrees, the two front V.A.P./S. Burner Units and the Rear Exhaust Unit begin to rotate in the same direction at the same rate. The CPU, through sensory feedback will regulate the air and fuel supply, and apportion these such that thrust produced in the two rear V.A.P./S. Burner Units is minimized in favor of the two front V.A.P./S. Burner Units and the Rear Exhaust Unit. This is accomplished by allowing increased airflow through to the combustion areas within the two main fuselage mounted jet engines while simultaneously diverting more air allocated for the V.A.P./S. Burner Units to the two front V.A.P./S. Burner Units. Thrust is monitored as needed so that there are equal and opposing forces acting upon both ends of the aircraft (factoring in the leverage advantage of the Rear Exhaust Unit).
   FIG. 7C-V.A.P./S. Braking Stage 2—the two front V.A.P./S. Burner Units and the Rear Exhaust Unit continue to rotate until they have both reached a vertical orientation, perpendicular to the fuselage, exhaust nozzles pointing downward.
   FIG. 7D-V.A.P./S. Braking Stage 3—at the moment a vertical orientation has been reached, the Rear Exhaust Unit begins to reverse direction while the two front V.A.P./S. Burner Units continue in their original direction of rotation. Each continues to rotate at the same rate (a micro delay in motion for the two front V.A.P./S. Burner Units may be necessary if there is any mechanical delay as the Rear Exhaust Unit changes its direction of rotation).
   FIG. 7E-V.A.P./S. Braking Stage 4—the two front V.A.P./S. Burner Units, having completed 180 degrees of rotation, and directly opposing the two rear V.A.P./S. Burner Units and the Rear Exhaust Unit, will now receive air and fuel in the maximum quantities at the expense of the two rear V.A.P./S. Burner Units and the Rear Exhaust Unit at a rate that will produce a well targeted landing position as calculated by the CPU taking into account factors including, but not limited to, velocity of aircraft, mass of aircraft, wind direction and speed, distance to target area, etc.
Rear Exhaust Unit #8
V.A.P./S. Jet/Rocket Burner Unit #11
   V.A.P./S. Angling Unit
   FIG. 8A-V.A.P./S. Angling Unit

The means by which the Extension Shafts on all of the V.A.P./S. Units are adjusted thereby allocating thrust from the Burner Units in varying ratios towards the functions of steering and stabilization.

FIG. 8B-V.A.P./S. Angling Unit (G Feedback Nullified)

The arrows in the illustration indicate the direction of gravitational force that would be levied against the linkage by the V.A.P./S. Units if they were not secured. As shown, the Right/Front and the Right/Rear V.A.P./S. Units (as well as the Left/Front and Left/Rear Units) cancel each other and therefore are unable to set the connective linkage into motion. The End Drive Shaft Brace is simply an added layer of protection. “X” indicates the point at which forces cancel one another eliminating feedback motion through the angling linkage.

FIG. 8C-V.A.P./S. Angling Unit (T Feedback Nullified)

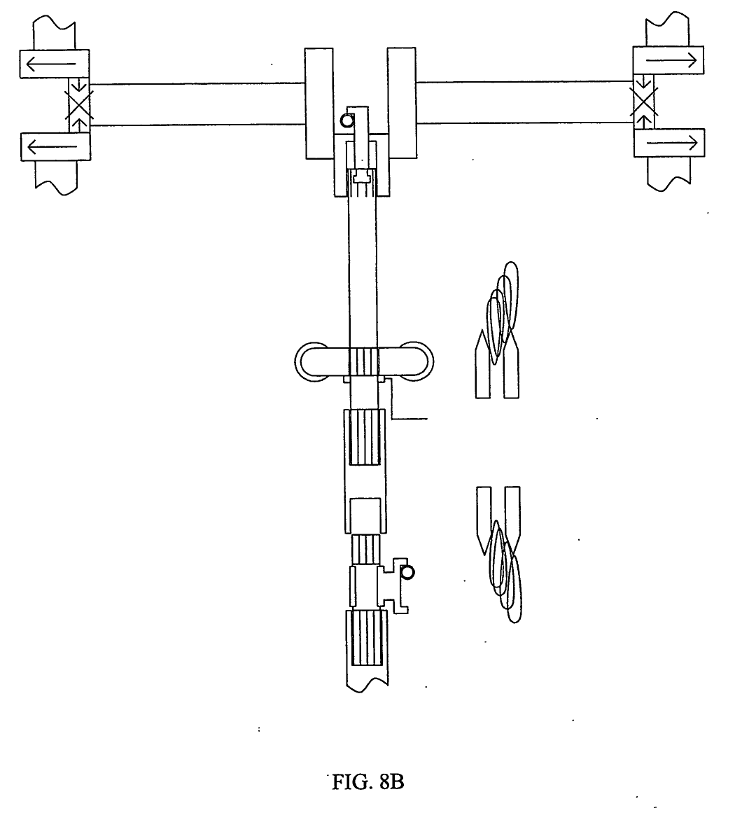

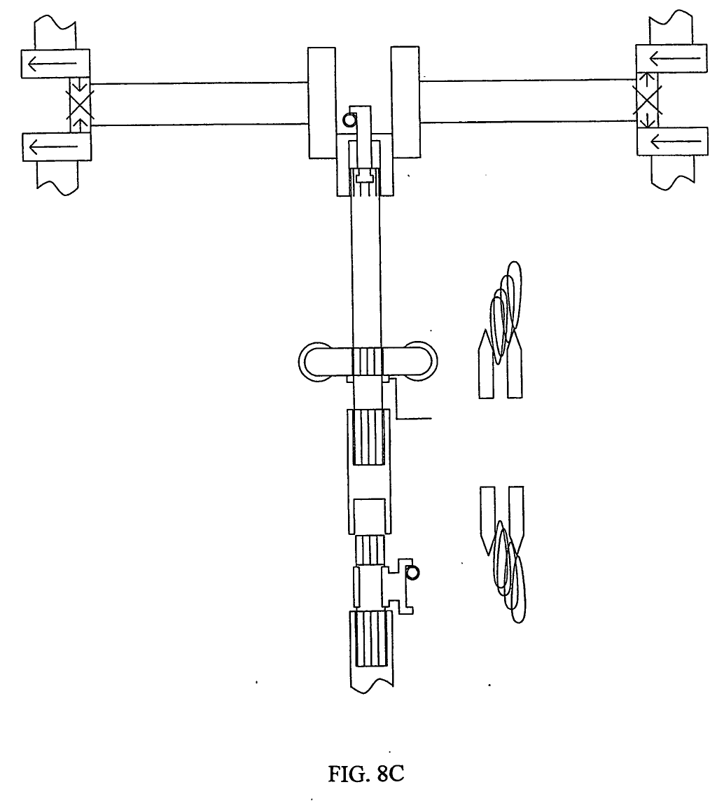

The arrows in the illustration indicate the direction of thrust force that would be levied against the linkage by the V.A.P./S. Units, during maneuvers, if they were not secured. As shown, the Right/Front and the Right/Rear V.A.P./S. Units (as well as the Left/Front and Left/Rear Units) cancel each other and therefore are unable to set the connective linkage into motion. The End Drive Shaft Brace is simply an added layer of protection. “X” indicates the point at which forces cancel one another eliminating feedback motion through the angling linkage.
Drive Shaft (1st Stage) #50
Splined Actuating Recess #50A
Sliding Drive Shaft (2nd Stage) #51
Splined Actuated Insert #51A
Splined Actuating Insert #51B
Yoke Actuating Gear—rotates at approximately twice the speed as the Drive Shaft so that the Sliding Drive Shaft Yoke may successfully engage the Splined Actuating Insert with the Intermediary Drive Shaft Splined Actuated Recess. The timing is based upon the sensory feedback received by the Main CPU from the End Drive Shaft Position Sensor. #52
Sliding Drive Shaft Yoke—contains an embedded sensor that sends feedback to the Main CPU, relaying the precise position of the Sliding Drive Shaft (2nd Stage). This allows the CPU to determine the exact speed required by the Yoke Actuating Gear to smoothly insert the Splined Actuating Insert into the Intermediary Drive Shaft Splined Actuated Recess, the position of which is determined and relayed to the CPU by the End Drive Shaft Position Sensor. #53
Intermediary Drive Shaft (3rd Stage) #54
Intermediary Drive Shaft Splined Actuated Recess #54A
Intermediary Drive Shaft Splined Actuating Recess #54B
End Drive Shaft (4th Stage) #55
End Drive Shaft Actuated Splined Insert #55A
End Drive Shaft Splined Bracing Insert #55B
End Drive Shaft Actuating Splined Insert #55C
End Drive Shaft Position Sensor—sends feedback to the C.P.U. relaying the precise position of the End Drive Shaft. This allows the C.P.U. to determine the exact speed required by the End Drive Shaft Stem Rack Gear to smoothly insert the End Drive Shaft Splined Bracing Insert into the End Drive Shaft Splined Bracing Receptor. #56
End Drive Shaft Brace #57
End Drive Shaft Splined Bracing Receptor—along with the End Drive Shaft Brace, prevents the angular setting of the V.A.P./S. Units from being altered by thrust from the V.A.P./S. Units (necessary during the braking process). #57A
V.A.P./S Angling Gear #58
V.A.P./S Angling Gear Actuated Splined Recess #58A
End Drive Shaft Stem Rack Gear—rotates at approximately twice the speed as the End Drive Shaft so that the End Drive Shaft Stem Rack may successfully engage the End Drive Shaft Splined Bracing Insert with the End Drive Shaft Splined Bracing Receptor. #59
End Drive Shaft Stem Rack #60
End Drive Shaft Stem Rack Spindle—allows the End Drive Shaft Actuating Splined Insert to spin freely while the End Drive Shaft is moved in either direction. #60A
V.A.P./S Angling Shaft (Stage 1) #61
V.A.P./S Angling Receptor Gear #61A
V.A.P./S Angling Actuating Gear #61B
V.A.P./S Angling Shaft (Front, Stage 2)—transmits motion to adjust the angling of the front V.A.P./S. Units. #62
V.A.P./S Angling Gear (Front, Stage 2) #62A
V.A.P./S Angling Shaft (Rear, Stage 2)—transmits motion to adjust the angling of the rear V.A.P./S. Units. #63
V.A.P./S Angling Gear (Rear, Stage 2) #63A
   Turbine/Compressor Gearings
   FIG. 9A—Turbine Compressor Gearings (Cut Away)
   FIG. 9B—Turbine Compressor Gearings (Cross Sectional)
Turbine Shaft—driven by an extended series of turbine blades.
Compressor Shaft—driven by the Turbine Shaft (via a series of multiplying gears), it revolves more than once for every one revolution of the Turbine Shaft. In the illustrated example, approximately 2:1.
Turbine Multiplying Gear—one revolution of this gear results in multiple revolutions of the Compressor Gear via the Turbine Intermediate Gear. The purpose is to maximize the volume of compressed air delivered to the V.A.P./S. Burner Units as well the combustion chambers of the primary jet engine(s) itself. It is possible due to the extended length of each of the jet engines which allows for additional series of axial turbine blades which extract more power from the expanding gasses escaping the combustion chambers thereby providing the additional torque required.
Turbine Intermediate Gear—driven by the Turbine Multiplying Gear it actuates the Compressor Gear. In this arrangement, it allows for both the Turbine Shaft and the Compressor Shaft to remain inline with one another, thereby providing the most economical configuration.
Compressor Gear—driven by the Turbine Multiplying Gear (via the Turbine Intermediate Gear), as it revolves so to does the Compressor Shaft to which are attached a series of compressor blades.
   V.A.P./S. Air Intake Feed (Top View)
   FIG. 10—V.A.P./S. Air Intake Feed (Top View)
Compressed Air—from the Air Distribution Chamber.
V.A.P./S. Air Intake Feed Diverter—assists the compressed air to divide more easily.
V.A.P./S. Air Intake Feed Valve—apportions the compressed air between the front and back V.A.P./S. Units.
72} V.A.P./S. Air Intake Cylinder—delivers compressed air to the V.A.P./S. Units where it is routed to the Burner Units and then to the Combustion Chambers.
   Air Distribution Unit (Top & Cross Section)

This unit is optional, as compressed air may be routed directly from each of the main jet engines' compressors to the V.A.P./S. Distribution Cylinders and ultimately on to the V.A.P./S. Burner Units. Its inclusion, however, does afford the following advantages: Airflow to the V.A.P./S. Burner Units may be more efficiently monitored and distributed by the CPU if that airflow emanates from one centralized source.

If there is any difference in the compressor output of any of the engines, the airflow to each of the individual V.A.P./S. Burner Units would remain uniform (unless operations/maneuvers dictated a disproportionate allocation as regulated by the CPU). Fully pivoting venting units, utilizing a small portion of the compressed air, would allow the aircraft to make lateral adjustments, particularly useful during VTOL operations, and to pivot in a clockwise, or counter-clockwise direction while hovering; also useful to lock and fire on multiple targets while hovering.

The presence of the Air Distribution Chamber would make it possible to eliminate the auxiliary starter engine by filling the chamber with highly compressed air prior to take-off. This air would then be released to the burner sections of the main engines wherein fuel would be added and mixed in the presence of an igniting element. If the mission repertoire includes low-orbit, trans-global deployment then the main jets would at some point, temporarily, discontinue operation. Prior to this planned shut down, the Air Distribution Chamber outlets would be closed while the Compressed Air Intake(s) would remain open causing the already compressed air entering to become super compressed. When the pressure within the Air Distribution Chamber nears the pressure threshold, the Compressed Air Intake(s) would also close as the main engines shut down. This store of super compressed air would provide the available source of compressed air to re-ignite the main engines after orbital re-entry, after which normal operations would resume. *From the period between exit and re-entry into the atmosphere, liquid oxygen and fuel would then be fed to the Combustion Chambers within each Burner Unit. The versatile application of thrust in any direction and at any angle, afforded by the V.A.P./S. System, would allow the Burner Units to apply a sustained braking counter-thrust as the aircraft descended from orbit in a controlled manner. While in orbit, the same maneuvering capabilities as is possible within the atmosphere would exist (at a faster rate) opening up a myriad of possible tactical, strategic, and defensive applications.

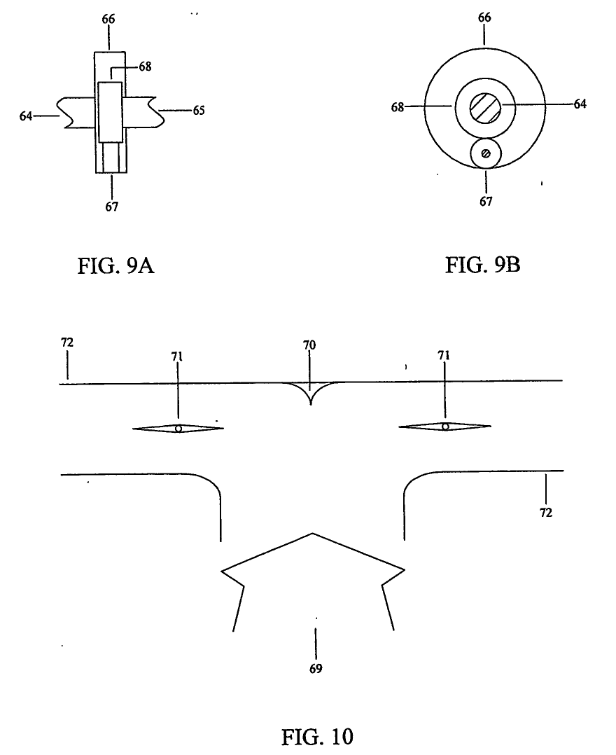

*Arrows indicate the direction of compressed airflow in FIGS. 11A and 11B.

FIG. 11A—Air Distribution Unit (Top)

FIG. 11B—Air Distribution Unit (Cross Section)

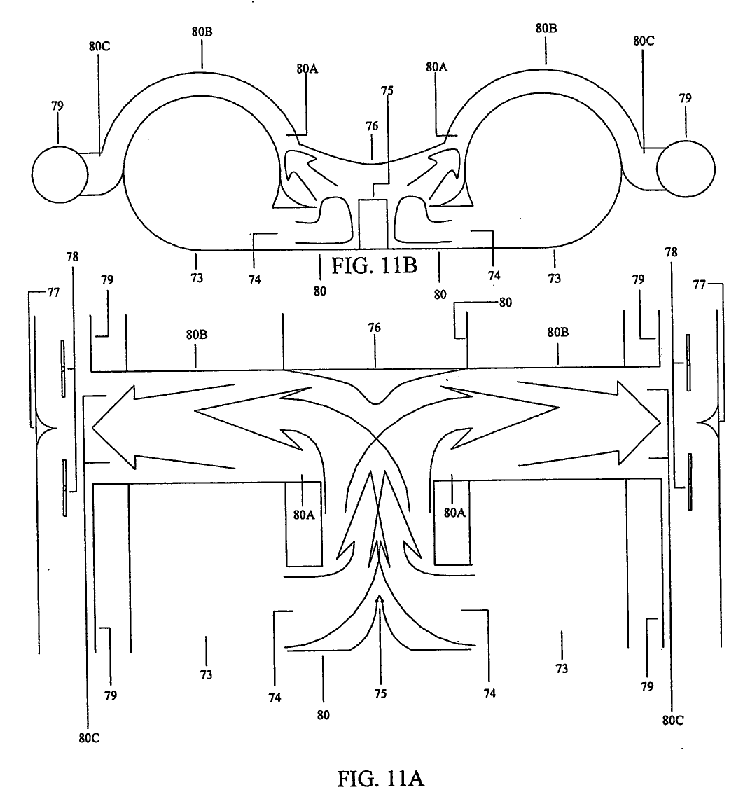

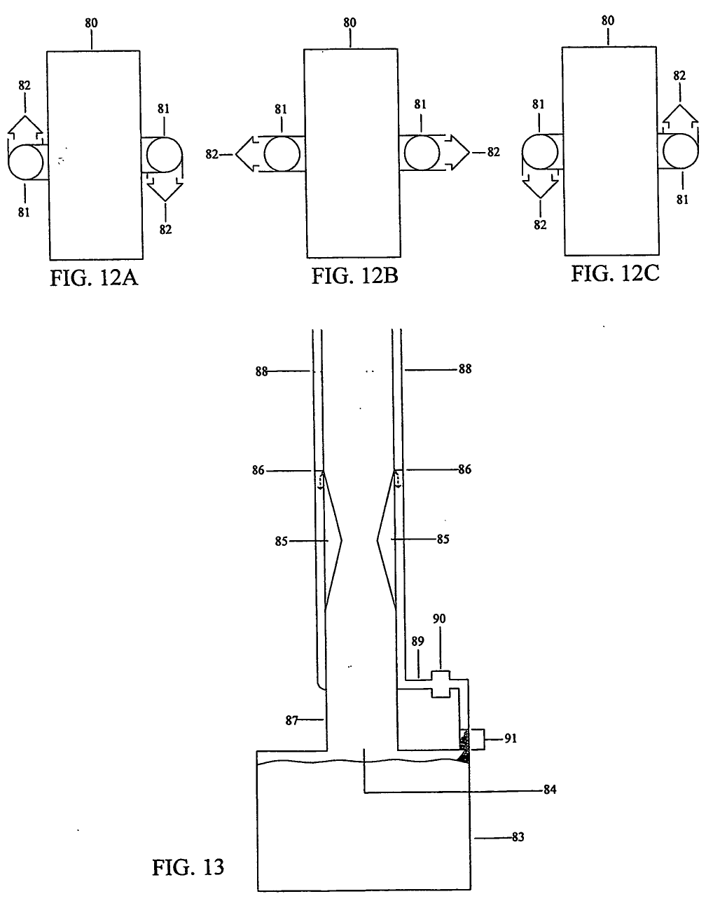

Turbine Compressor Section—having an internal valve (not shown), which is controlled by the CPU, it determines the proportion of compressed air delivered to the Air Distribution Chamber and the proportion allowed to flow through to the primary jet engine's combustion chambers.
   Compressed Air Intake (for the Air Distribution Chamber)
Entry Diverter—allows compressed air from both compressors to blend more smoothly. *It may be desirable to incorporate some type of supplemental ram intake for certain applications of the V.A.P./S. System. In such a case, a one-way valve could be incorporated whereby the sufficiently compressed air from the ram intake might enter the Air Distribution Chamber through the Entry Diverter at a point of least resistance, thereby increasing the total available mass of compressed air while still allowing the aircraft's primary C.P.U. to account for all of the available compressed air and maintain more precise allocations to each of the Burner Units according to the situation at hand.
Exit Diverter—allows compressed air from Air Distribution Chamber to exit more smoothly.
V.A.P./S. Distribution Cylinder Diverter—allows compressed air from the Air Distribution Chamber to separate more smoothly.
V.A.P./S. Distribution Cylinder Apportioning Valves—governed by the CPU, these valves operate independently of one another and regulate the proportion of compressed air delivered to each of the four V.A.P./S. Units. The amount of fuel injected into the V.A.P./S. Burner Units' combustion chambers is adjusted by the CPU accordingly.
V.A.P./S. Distribution Cylinder—delivers compressed air to the V.A.P./S. Units.
Air Distribution Chamber—collects compressed air from both axial compressors and distributes it to both V.A.P./S. Distribution Cylinders. Even if one of the jet engines became inoperative, while there would be a 50% decrease in total power output, the aircraft would be able to maintain controlled flight.
80A) V.A.P./S. Air Distribution Chamber Outlet
80B) V.A.P./S. Distribution Chamber Bridge—contained within the hull of the aircraft, it delivers compressed air from the Air Distribution Chamber to the V.A.P./S. Distribution Cylinder.
80C) V.A.P./S. Chamber Bridge Compressed Air Outlet
   Lateral/Pivoting Control System
   FIG. 12A-Counter Clockwise
   FIG. 12B-Left/Right
   FIG. 12C-Clockwise
   Air Distribution Chamber
Venting Units—are able to rotate 360 degrees (although no more than 270 degrees of rotation would suffice) venting a small portion of the compressed air in opposite directions while pivoting. To effect lateral movement compressed air may be released from one Venting Unit, or from both Venting Units aligned in the same direction. Fore and aft adjustments (and any other directional movements) to the aircraft are equally feasible.
Compressed Air—is vented through valves (not shown) from fully rotatable nozzles effecting lateral and pivoting maneuvers.
   Double-Walled Vacuum Fuel Line and Fuel Coupling
   FIG. 13-Fuel Line (not to scale) without any separation and numbered parts. *For an overview see FIG. 4, parts 36, 37, 37A.
Fuel Tank
Fuel Tank Outlet
Nozzle Seat—one of a number of acceptable methods to link one section of Fuel Line with another.
Fuel Line Joint—if there is any fuel leakage (slight if any), it will not be permitted to escape into the Compressed Air Conduit due to a double layered line and a constant vacuum that returns droplets and/or fumes to the fuel tank (exemplified in FIG. 13, adjacent to the Fuel Line Joint).
Inner Housing—primary carrier of fuel to the Burner Unit's combustion chambers.
Vacuum Wall Housing—creates a barrier between the Fuel Line (especially at its joints) and the Compressed Air Conduit.
Fuel Line Vacuum Conduit—pathway through which any leakage (droplets, fumes) is returned to the Fuel Tank via a vacuum.
Fuel Line Vacuum—revolving blades create a pressure differential on either side of it causing the air to flow towards the Fuel Tank.
Uni-Directional Valve—if enough fuel has leaked over an extended period of operation the two stage valve will allow fuel to return yet not exit (exemplified in FIG. 13 entering through the first stage of the Uni-Directional Valve, and again through the second stage of the Uni-Directional Valve into the Fuel Tank).

An alternative configuration of the invention within the scope of the claims that follow may incorporate a Burner Unit at the tip of each wing that is rotated up and down, each one opposite the direction of the other. Yaw control may be accomplished by conventional rudder and/or by placing a Burner Unit at the rear that is rotated left and right. The effect would be steering or yaw impetus at the rear, and roll control on both sides. Pitch control can be conventional, or augmented by having the same or other rear Burner Units that are rotated up and down.

The term “aircraft” as used in the claims encompasses any mobile platform or vehicle, manned or unmanned, intended for maneuvering within or transitioning between three dimensional, non-solid mediums including space, water, and air.

One embodiment of the present invention provides an aircraft with directional thrust control including: an airframe, an onboard primary power source producing compressed air, and at least two thrust producing modules disposed peripherally on the airframe, each of the thrust producing modules is connected to the power source for receiving a flow of the compressed air, each such thrust producing module is connected to a fuel source, each of the thrust producing modules is attached to a respective thrust producing module support structure, each such support structure is configured with directionally variable means for varying the thrust angle of the thrust producing module with respect to the roll axis of the aircraft, all the thrust producing modules are connected to a common controller for coordinated control of the aircraft.

An alternative embodiment of the present invention provides such an aircraft in which the directionally variable means includes a first rotatable joint perpendicular to the roll axis of the aircraft and a second rotatable joint parallel to the roll axis of the aircraft. The common controller and the thrust producing modules may also include means for controlling the amount of thrust produced by each of the thrust producing modules, apportioning the total thrust among the thrust producing modules, and controlling the angle of thrust of each of the modules. The module support structure and the first rotable joint permits rotation of respective the thrust producing module in a first axis of rotation over a range of at least 180°, and the second rotable joint permits rotation of the thrust producing module in a second axis of rotation over a range of at least 90°. The first axis of rotation may be near the thrust producing module, and the second axis of rotation may be near the airframe.

An aircraft according to one embodiment of the present invention may also include a system including at least four thrust producing modules.

An aircraft in accord with one embodiment of the present invention may also include a source of liquid oxygen available to each module. The thrust producing modules may also have combustion chambers and exhaust outlets and exhaust pistons whereby the thrust may be controlled.

In yet another embodiment of the present invention thrust producing modules further may include and are powered by powering an electrical generator for producing at least enough electrical energy required for operation of the module.

One embodiment of the present invention may also include a rearward directed, in-line source of thrust. The rearward, in-line source of thrust may be angularly rotatable with respect to at least the pitch axis or the rearward, in-line source of thrust may be at least one additional thrust producing module.

Another embodiment of the present invention includes a primary power source comprising at least one jet engine that may include a rearward directed, in-line source of thrust.

The aircraft may include a center of rotation common to pitch, roll and yaw axes, and a cockpit located proximate said center of rotation. The airframe may include a heat shield on the underside thereof.

An embodiment of the present invention provides an aircraft with directional thrust control including an airframe, an onboard primary power source producing compressed air, at least two thrust producing modules disposed peripherally on the airframe, each thrust producing module connected to the power source for receiving a flow of the compressed air, each thrust producing module connected to a fuel source, each thrust producing module attached to a respective thrust producing module support structure, each support structure configured with a first rotatable joint perpendicular to the roll axis of said aircraft and a second rotatable joint parallel to the roll axis of the aircraft for varying the thrust angle of the thrust producing module with respect to the roll axis of the aircraft, and all the thrust producing modules being connected to a common controller for coordinated control of the aircraft, the aircraft including a center of rotation common to pitch, roll and yaw axes, and a cockpit located near the center of rotation. An alternative embodiment includes four thrust producing modules. These embodiments may have a first rotatable joint permitting rotation of respective thrust producing module in a first axis of rotation over a range of at least 180°, and a second rotatable joint permitting rotation of the thrust producing module in a second axis of rotation over a range of at least 90°.

An embodiment of the present invention provides an aircraft with directional thrust control including: an airframe, an onboard primary power source producing compressed air, at least four variable angle thrust producing modules disposed on the airframe, each thrust producing module connected to the power source for receiving a flow of compressed air, each thrust producing module connected to a fuel source, each thrust producing module attached to a respective thrust producing module support structure, each support structure configured with rotatable joints for varying the thrust angle of the thrust producing module, all thrust producing modules being connected to a common controller for coordinated control of the aircraft, the aircraft comprising a center of rotation common to pitch, roll and yaw axes, and a cockpit located proximate to the center of rotation.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. An aircraft with directional thrust control comprising:
an airframe,
an onboard primary power source producing compressed air, and
at least two thrust producing modules disposed peripherally on said airframe, each said thrust producing module connected to said power source for receiving a flow of said compressed air, each said thrust producing module connected to a fuel source, each said thrust producing module attached to a respective thrust producing module support structure, each said support structure configured with directionally variable means for varying the thrust angle of said thrust producing module with respect to the roll axis of said aircraft, all said thrust producing modules being connected to a common controller for coordinated control of said aircraft.

2. An aircraft according to claim 1, said directionally variable means comprising a first rotatable joint perpendicular to said roll axis of said aircraft and a second rotatable joint parallel to said roll axis of said aircraft.

3. An aircraft according to claim 1, said common controller and said thrust producing modules comprising means for
controlling the amount of thrust produced by each said thrust producing module,
apportioning the total thrust among said thrust producing modules, and
controlling the angle of thrust of each said module.

4. An aircraft according to claim 2 each said module support structure comprising said first rotable joint permits rotation of respective said thrust producing module in a first axis of rotation over a range of at least 180°, and said second rotable joint permits rotation of said thrust producing module in a second axis of rotation over a range of at least 90°.

5. An aircraft according to claim 4 wherein said first axis of rotation is proximate said thrust producing module, and wherein said second axis of rotation is proximate said airframe.

6. An aircraft according to claim 5 wherein said system comprises at least four said thrust producing modules.

7. An aircraft according to claim 1, further comprising a source of liquid oxygen available to each said module.

8. An aircraft according to claim 1, said thrust producing modules having combustion chambers and exhaust outlets and further comprising exhaust pistons whereby thrust may be controlled.

9. An aircraft according to claim 3, each said thrust producing module further comprising and powering an electrical generator for producing at least enough electrical energy required for operation of said module.

10. An aircraft according to claim 3 further comprising a rearward directed, in-line source of thrust.

11. An aircraft according to claim 10, said rearward, in-line source of thrust being angularly rotatable with respect to at least said pitch axis.

12. An aircraft according to claim 10, said rearward, in-line source of thrust being at least one additional said thrust producing module.

13. An aircraft according to claim 3, said primary power source comprising at least one jet engine.

14. An aircraft according to claim 13, said jet engine further comprising a rearward directed, in-line source of thrust.

15. An aircraft according to claim 3, said aircraft comprising a center of rotation common to pitch, roll and yaw axes, and further comprising a cockpit located proximate said center of rotation.

16. An aircraft according to claim 3, said airframe further comprising a heat shield on the underside thereof.

17. An aircraft with directional thrust control comprising:
an airframe,
an onboard primary power source producing compressed air,
at least two thrust producing modules disposed peripherally on said airframe, each said thrust producing module connected to said power source for receiving a flow of said compressed air, each said thrust producing module connected to a fuel source, each said thrust producing module attached to a respective thrust producing module support structure, each said support structure configured with a first rotatable joint perpendicular to the roll axis of said aircraft and a second rotatable joint parallel to said roll axis of said aircraft for varying the thrust angle of said thrust producing module with respect to said roll axis of said aircraft, and all said thrust producing modules being connected to a common controller for coordinated control of said aircraft, said aircraft comprising a center of rotation common to pitch, roll and yaw axes, and
a cockpit located proximate said center of rotation.

18. An aircraft according to claim 17, said at least two thrust producing modules being four thrust producing modules.

19. An aircraft according to claim 18, further comprising within each said module support structure said first rotable joint permitting rotation of respective said thrust producing module in a first axis of rotation over a range of at least 180°, and said second rotable joint permitting rotation of said thrust producing module in a second axis of rotation over a range of at least 90°.

20. An aircraft with directional thrust control comprising:
an airframe,
an onboard primary power source producing compressed air,
at least four variable angle thrust producing modules disposed on said airframe, each said thrust producing module connected to said power source for receiving a flow of said compressed air, each said thrust producing module connected to a fuel source, each said thrust producing module attached to a respective thrust producing module support structure, each said support structure configured with rotatable joints for varying the thrust angle of said thrust producing module, all said thrust producing modules being connected to a common controller for coordinated control of said aircraft, said aircraft comprising a center of rotation common to pitch, roll and yaw axes, and
a cockpit located proximate said center of rotation.
